(19) United States
(12) Patent Application Publication
(10) Pub. No.: US 2009/0300065 A1
(43) Pub. Date: Dec. 3, 2009

(54) COMPUTER SYSTEM AND METHODS FOR IMPROVING IDENTIFICATION OF SUBROGATION OPPORTUNITIES

(76) Inventor: James T. Birchall, Southwick, MA (US)

Correspondence Address: BUCKLEY, MASCHOFF & TALWALKAR LLC, 50 LOCUST AVENUE, NEW CANAAN, CT, 06840, US

(21) Appl. No.: 12/129,956

(22) Filed: May 30, 2008

(51) Int. Cl. G06F 17/30; G06Q 40/00; G06Q 10/00; G06F 19/00

(52) U.S. Cl. 707/104.1; 705/4; 705/9; 701/33; 707/E17.009

(57) ABSTRACT

A computer system includes a data capture module for capturing at least one of a make, a model and a unit identification number for a vehicle involved in a loss event. The system further includes a data storage module for storing the at least one of a make, a model and a unit identification number. A computer processor analyzes information related to the vehicle to detect a pattern of reported problems involving the vehicle. An output device outputs an identification of a subrogation opportunity based on the detected pattern.

### FIELD

The present invention relates to computer systems and more particularly to computer systems that perform database searches and engage in data mining.

### BACKGROUND

Generally, subrogation refers to an insurer's right to recover losses paid under insurance contracts from parties legally liable for the damages. FIG. 1 is a flow chart that illustrates a conventional practice by which an insurance company may identify subrogation opportunities with respect to claim files.

The claim-handling process in an insurance company is instigated by receipt of a “first notice of loss”, as represented at 102 in FIG. 1. Typically, in cases of damage to a vehicle or structure, the resulting claim file may be assigned to an “estimator” who takes steps (represented at 104) to determine the cost to repair the damage. The estimator gathers information concerning loss for input into the insurance company's computer system. A claim handler further administers the claim, including investigation of the event that resulted in the claim, resolution of any coverage issues, and settlement with the insured or claimant. The claim handler's activities are indicated at 106. Upon the claimant's acceptance of payment for the claim, the claim is considered resolved and the file is closed (block 108), from the point of view of the claim-handling organization within the insurance company.

The claim file may be reviewed by a subrogation unit of the insurance company to determine whether there are opportunities for the insurance company to recover, from a liable third party, some or all of the amount paid on the claim. The review of the claim file by the subrogation unit is indicated at 110 in FIG. 10. To give a typical example, in the case of an automobile accident, the subrogation unit may review the claim file to determine that a party other than the insured was at least partly at fault for the damage it paid. If so, and if a subrogation claim appears justified, the subrogation unit may prepare a subrogation demand for submission to a third party. (To provide a more specific example, if the insurer covered and paid for property damage to a vehicle that was rear-ended by another vehicle, that insurer may submit a subrogation demand to the insurer of the other vehicle.)

The present inventor has now recognized certain ways in which information technology may be adapted and put to work and conventional practices may be modified so as to enhance an insurance company's capabilities for identifying opportunities for subrogation.

### SUMMARY

According to one aspect of the invention, a computer system includes a data capture module for capturing at least one of a make, a model and a unit identification number for a vehicle involved in a loss event. The computer system also includes a data storage module in communication with the data capture module. The data storage module is for storing the at least one of a make, a model and a unit identification number for the vehicle involved in the loss event. The computer system further includes a computer processor in communication with the data storage module for analyzing information related to the vehicle to detect a pattern of reported problems involving the vehicle. In addition, the computer system includes an output device, coupled to the computer processor, for outputting an identification of a subrogation opportunity based on the detected pattern.

According to another aspect, an apparatus, method, computer system and computer-readable data storage medium are disclosed which include receiving, in a computer, first data that represents at least one of a make, a model and a unit identification number for a physical object involved in a loss event. Further included are the steps of receiving, in the computer, second data that represents at least one attribute of the loss event not indicated by the first data, and the computer accessing at least one database using at least one of the make, the model and the unit identification number to receive or gather third data from the at least one database. Also included are the steps of the computer using at least the second and third data to identify a subrogation opportunity with respect to the loss event, and the computer outputting the identified opportunity to a workflow device.

In a further aspect, an apparatus, method, computer system and computer-readable data storage medium are disclosed which include receiving in a computer first information that represents a make and model for a physical object involved in a loss event, the computer automatically analyzing second information to detect a pattern of reported problems involving the make and model, the computer automatically identifying a subrogation opportunity based on the detected pattern, and the computer outputting to an output device third information indicative of the identified subrogation opportunity.

In still a further aspect, a computer system includes a data capture module for capturing at least one of a make, a model and a unit identification number for a vehicle involved in a loss event. The computer system also includes a data storage module in communication with the data capture module. The data storage module is for storing the at least one of a make, a model and a unit identification number for the vehicle involved in the loss event. The computer system further includes a computer processor in communication with the data storage module for (a) analyzing information related to the vehicle to detect a pattern of reported problems involving the vehicle, (b) accessing at least one vehicle history database to determine a prior repair history for the vehicle, and (c) accessing a vehicle recall database to determine whether said vehicle has been subject to a manufacturer's recall. In addition, the computer system includes an output device, coupled to the computer processor, for outputting an identification of a subrogation opportunity based on at least one of (a) the detected pattern, (b) the prior repair history for the vehicle, and (c) the manufacturer's recall.

In yet another aspect, an apparatus, method, computer system and computer-readable data storage medium are disclosed which include determining a make, a model and a vehicle identification number for a motor vehicle that has been involved in an accident, using the make and model to access a vehicle recall database to determine whether the motor vehicle has been subject to a manufacturer's recall, using the vehicle identification number to access at least one vehicle history database to determine a prior repair history for the motor vehicle, using the make and model to search the internet and/or at least one website to detect a pattern in reported problems involving the make and model, identifying a subrogation opportunity based on at least one of (a) the access to the vehicle recall database, (b) the access to the at least one vehicle history database and (c) the detected pattern of reported problems, and outputting the subrogation opportunity to a workflow device.

One or more of these computer-implemented systems or methods may allow for greater possibilities for identifying subrogation opportunities, particularly in regard to loss events caused by product defects. Consequently, an insurance company that employs such systems or methods may enhance its ability to recoup payments that it has made on claims.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a flow chart that illustrates a conventional process that may result in identification of subrogation opportunities.

FIG. 2 is a flow chart that illustrates a process provided in accordance with aspects of the present invention for enhanced identification of subrogation opportunities.

FIG. 3 is a functional block diagram of a system provided in accordance with aspects of the present invention for enhanced identification of subrogation opportunities.

FIG. 4 is a block diagram that provides another representation of aspects of the system of FIG. 3.

FIG. 5 is a block diagram representation of a computer that may form part of the system of FIG. 3 or 4.

FIG. 6 is a flow chart that illustrates a process that may be performed by the computer depicted in FIG. 5.

FIG. 7 schematically represents a process by which a repair shop may be recommended in accordance with other aspects of the invention.

FIG. 8 is a flow chart that further illustrates the process of FIG. 7.

### DETAILED DESCRIPTION

In general, and for the purposes of introducing concepts of embodiments of the present invention, information gathered during an estimation process and the beginning of the handling of a claim is forwarded for consideration of subrogation opportunities while the estimation process continues. The information may relate to the make, model, model year and unit number and/or identification code for a motor vehicle or other manufactured product involved in the loss event. The information concerning the product may be used for hard database searches or “softer” data mining and pattern recognition processing to identify product recalls or reports of problems relating to the product. This searching or processing may thus allow for identification of opportunities for subrogation demands based on possible product liability on the part of the product manufacturer in relation to the causation of the loss event. Other possible subrogation opportunities may be identified with respect to prior repair history for a vehicle, particularly if the repair shop which performed the repair lacked proper capabilities for performing the repair. Databases that reflect repair shop capabilities, and thus are useful for identification of subrogation possibilities, may also be useful in an automated process for identifying vehicle damage and identifying qualified repair shops for recommendation to perform repairs.

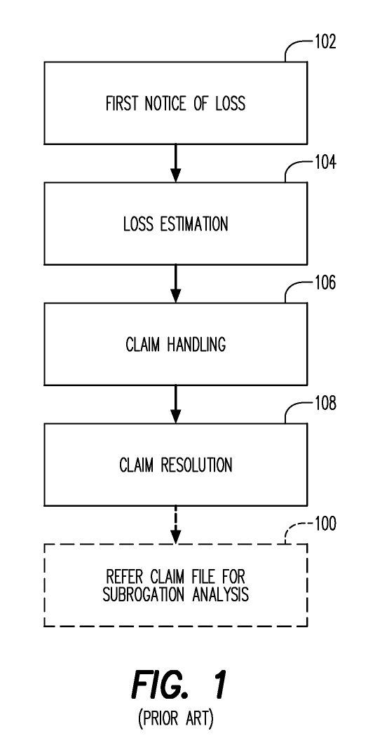

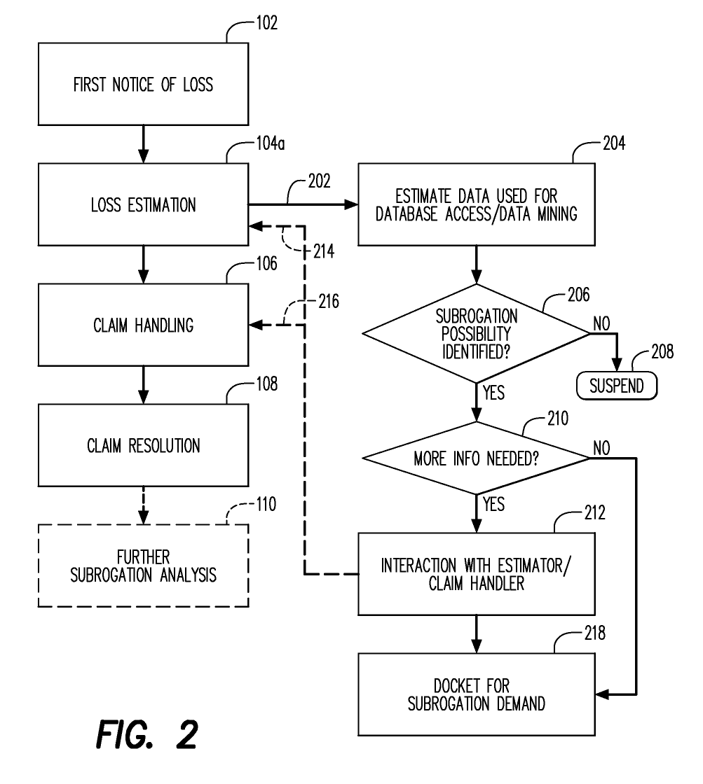

FIG. 2 is a flow chart that illustrates a modification of the process of FIG. 1 in accordance with aspects of the present invention.

The process of FIG. 2 starts with the same first block 102 (first notice of loss) as in FIG. 1. A modified estimation process 104a may occur next. For example, the estimation process may include gathering of additional information and/or placing that information in an enhanced information format. The additional information or enhanced format may, for example, include gathering of information concerning one or more manufactured products or other physical objects that may have played a role in causing the loss event. In one salient example, in the case where the loss event was a motor vehicle accident, the information gathered at 104a may include the make, model, model year and vehicle identification number (VIN) of every vehicle involved in the accident. In such a case, the information may further include the make and model of all tires on the vehicles involved in the accident. The information gathered may also include the make and model of other original or aftermarket equipment identified by a make or model other than that of the vehicle itself.

The estimate data may also include, e.g., a description of the accident in sufficient detail to indicate the role (e.g., hit head on, went off the road, rear-ended another vehicle, rear-ended by another vehicle, etc.) of each vehicle in the accident. The vehicles' roles in the accident may be considered attributes of the accident other than the make, model, year and VIN of the vehicles involved.

The information gathered may also include an indication that the loss event involves bodily injury, or the possibility of bodily injury.

In other examples, the loss event may involve a building. For example, the loss event may involve a building fire, smoke damage, heat damage, water damage or an explosion. The information may include the make, model and, if available, the unit serial number, of one or more appliances that were present in the building at the time of the loss event. Examples of such appliances may include the furnace or boiler, the hot water heater, the clothes washing machine, the clothes drying machine, the dishwashing machine, the stove or range, etc. This information, as will be seen, may be helpful for identifying possible subrogation opportunities in cases where there has been a pattern of loss events possibly caused by defects in a particular make and model of appliance.

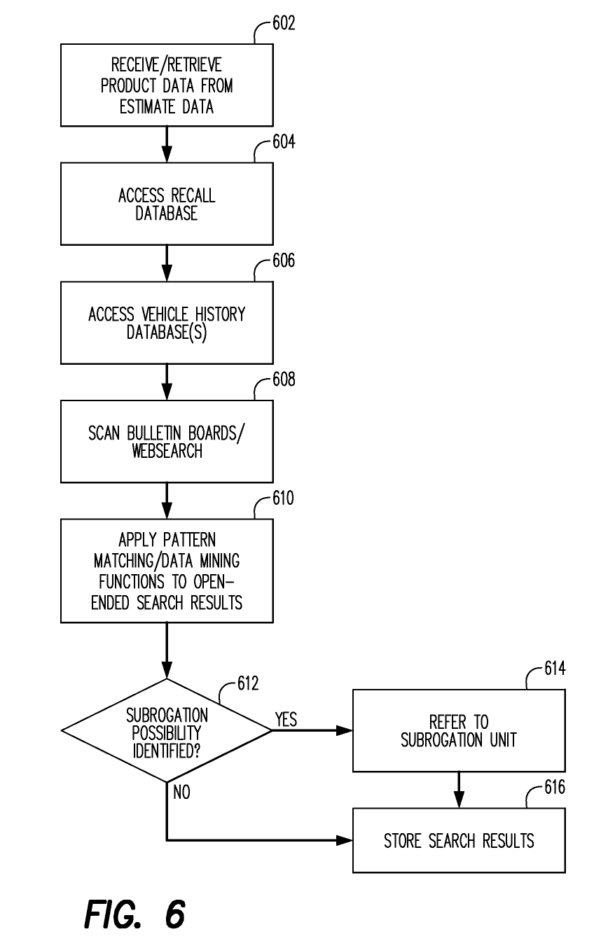

As indicated at 202, product information or the like may be forwarded for use in identifying subrogation opportunities, even while the estimation process continues. Block 204 represents use of the product information in connection with database searching, web searching, data mining, pattern detection and/or other processing that may locate information to indicate that a product defect may be implicated in the causation of the loss event. Details of example processes performed at 204 will be described below in more detail in connection with FIG. 6. Suffice it for the moment to note that the activities at 204 may include searching databases such as product recall databases or vehicle history databases for “hard” indicators of defects such as product recalls or prior accidents, and also detection of “soft” indicators, such as patterns in reported problems for a particular product that may be suggestive of a defect that has yet to be formally acknowledged.

At decision block 206, it is determined whether the activities of block 204 have resulted in identification of a subrogation opportunity. If not, and as indicated at 208, attempts to identify subrogation opportunities for the file may be suspended until the file is closed, at which time a human subrogation specialist may review the claim file, as per block 110 in FIGS. 1 and 2.

Considering again decision block 206, if a positive determination is made at that decision block (i.e., if a subrogation opportunity has been identified), the process advances from decision block 206 to decision block 210. At decision block 210, it is determined whether further information is required in connection with the subrogation opportunity. If so, the process advances to block 212. At block 212, one or more requests for additional information may be sent to the estimator (per dashed line 214) and/or to the claim handler (per dashed line 216).

The process further advances from block 212 to block 218. (Alternatively, if at decision block 210 it was determined that no further information is needed, then block 218 follows decision block 210.) At block 218, the claim file in question is docketed for possible preparation and submission of a subrogation demand. The claim file may thereafter be taken up in due course for appropriate handling by subrogation unit personnel.

In some embodiments, all of the processing represented by blocks 204, 206, 208, 210, 212 and 218 may be performed automatically by one or more suitably programmed computers. An example of such a computer will be described below.

The process of FIG. 2 may also include the activities described above in connection with blocks 106 and 108 in FIG. 1. These activities are represented by the same blocks in FIG. 2. However, the estimating and claim handling activities of blocks 104a and 106 may, in the case of the process of FIG. 2, also include gathering of information and providing responses with respect to requests for additional information concerning subrogation opportunities. Such requests are, as noted above, indicated at 214 and 216 in FIG. 2.

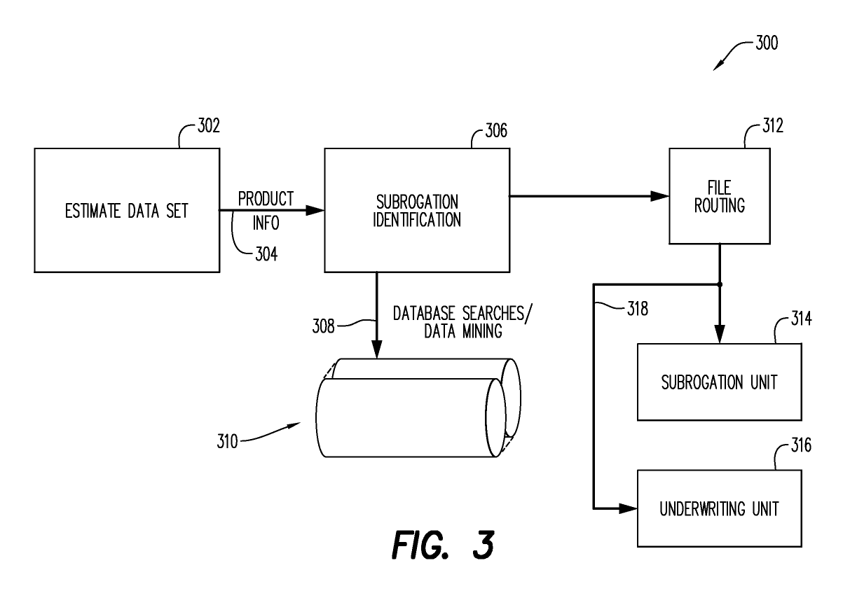

FIG. 3 is a functional block diagram of a system 300 provided in accordance with aspects of the present invention for enhanced identification of subrogation opportunities.

As noted above, for each claim the estimating process results in preparation of a set of estimate data provided in a prescribed format. The estimate data set is indicated at 302 in FIG. 3. In accordance with aspects of the present invention, the estimate data set includes data that identifies one or more manufactured products that may have been involved in the loss event. (Block 302 may also be considered to represent a notebook computer or other device that may be suitable for capturing the estimate data set. At least some of the estimate data set may be as described above in conjunction with block 104a (FIG. 2). The notebook computer 302 may be considered to be a data capture module which can transmit the estimate data set to the data processing equipment 306 discussed below.) The estimate data set, or at least the product information included therein, is provided as an input 304 to data processing equipment 306 which automatically performs processes for identifying subrogation possibilities. As indicated at 308, the subrogation identification data processing equipment 306 performs database searches and/or data mining activities or the like with respect to one or more databases or other data repositories, all of which are indicated at 310 in FIG. 3. (The data processing equipment 306 may also include a data storage module which is not separately shown and which stores the estimate data set.)

With respect to claim files for which the subrogation identification data processing equipment 306 identifies a subrogation opportunity, the subrogation identification data processing equipment 306 forwards the claim file in question to a file routing module 312. The file routing module 312, in turn, forwards the claim file to a subrogation unit 314. The subrogation unit is responsible for such activities as gathering further information (if required), evaluating the desirability of pursuing subrogation with respect to the claim file, and preparing and prosecuting a subrogation demand. (In addition to representing the subrogation unit, block 314 may be taken to represent one or more personal computers that may receive the claim files and indications of subrogation opportunities and may output the same to employees in the subrogation unit. Thus block 314 may represent an output device or a workflow device.)

Block 316 represents an underwriting unit of the insurance company. As indicated at 318, the underwriting unit 316 may receive output from the file routing module 312 to indicate manufactured products that have been implicated in connection with subrogation opportunities. The underwriting unit may base one or more underwriting decisions at least in part on this information. For example, if a certain make, model and year of a vehicle has exhibited a possible defect, the premiums charged for covering that type of vehicle may be set accordingly.

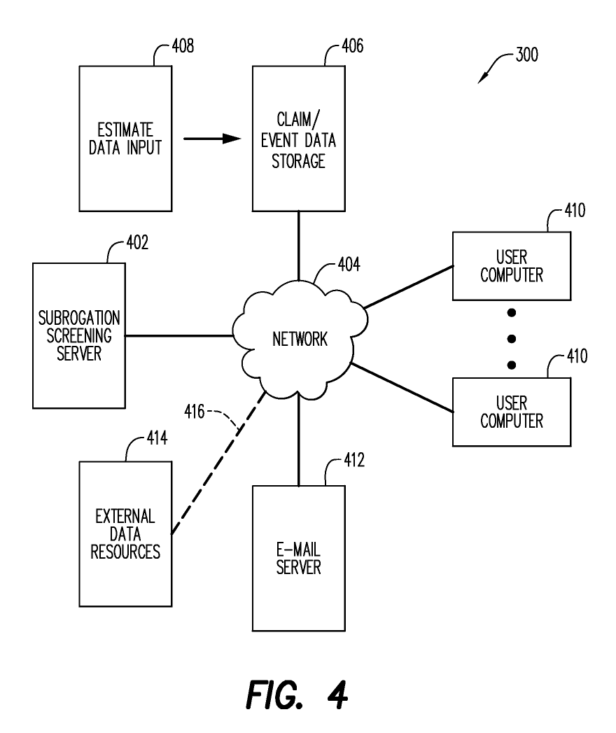

FIG. 4 is a block diagram that provides another representation of aspects of the system 300 of FIG. 3.

The computer system 300, as depicted in FIG. 4, includes a server computer 402. Possibly among other functions, the server computer 402 may provide functionality for automatically identifying subrogation opportunities based on information relating to manufactured products involved in loss events and based on database searches, data mining and the like. The server computer 402 may be referred to as a “subrogation screening server computer”, notwithstanding that it may perform other functions as well. The subrogation screening server computer 402 may constitute some or all of the data processing equipment 306 referred to above in connection with FIG. 3.

As seen from FIG. 4, the computer system 300 may further include a conventional data communication network 404 to which the subrogation screening server computer 402 is coupled.

FIG. 4 also shows, as part of computer system 300, a data storage device 406 that is coupled to the data communication network 404. The data storage device 406 may, for example, be constituted by one or more hard disk drives and/or any other known mass data storage device. The data storage device 406 may be constituted as part or parts of one or more server computers, which are not separately shown. Although shown as separate from the subrogation screening server computer 402, in some embodiments the data storage device 406 may be integrated with the subrogation screening server computer 402. The data storage device 406 may be a central storage facility for all of the insurance company's files relating to claims and related loss events. Moreover, the computer system utilized by the insurance company as the central repository of electronic claim files may also perform other functions, including those described herein.

As indicated at 408, one of the sources of the claim/event data stored in the data storage device 406 may be the estimate data generated by estimators as referred to above, and preferably formatted in a prescribed manner.

Still further, FIG. 4 shows, as parts of the computer system 300, personal computers 410 assigned for use by individual employees of the insurance company, including, e.g., employees in the subrogation unit 314 (FIG. 3) who are charged with preparing and prosecuting subrogation demands. Also, some of the personal computers 410 may be operated by estimators who perform the activities referred to in connection with blocks 104 or 104a in FIG. 1 or 2. Continuing to refer to FIG. 4, the personal computers 410 are coupled to the data communication network 404.

Also included in the computer system 300, and coupled to the data communication network 404, is an electronic mail server computer 412. The electronic mail server computer 412 provides a capability for electronic mail messages to be exchanged among the other devices coupled to the data communication network 404.

Thus the electronic mail server computer 412 may be part of an electronic mail system included in the computer system 300.

For functional purposes, the computer system 300 may also be considered to include one or more external data sources 414 that are not maintained by the insurance company but are nonetheless accessible by computers that are operated by the insurance company. The external data sources 414 may, for example, include various databases that are publicly available and/or are available by subscription or membership. The data resources may, for example, include one or more databases that store information concerning product recalls. More specifically, the product recall databases may each be concerned with different types of products, such as a motor vehicle recall database, a household appliance recall database, etc.

Other external data sources 414 may be considered to include the internet as a whole and search engines that are publicly available for searching the internet Still other external data sources 414 may include websites that collect or allow consumers to post comments concerning, and/or reviews of, various types of products.

The computer system 300 or components thereof may access the external data sources 414 via the data communication network 404, and/or via one or more public or dedicated private data communication networks, as represented at 416 in FIG. 4.

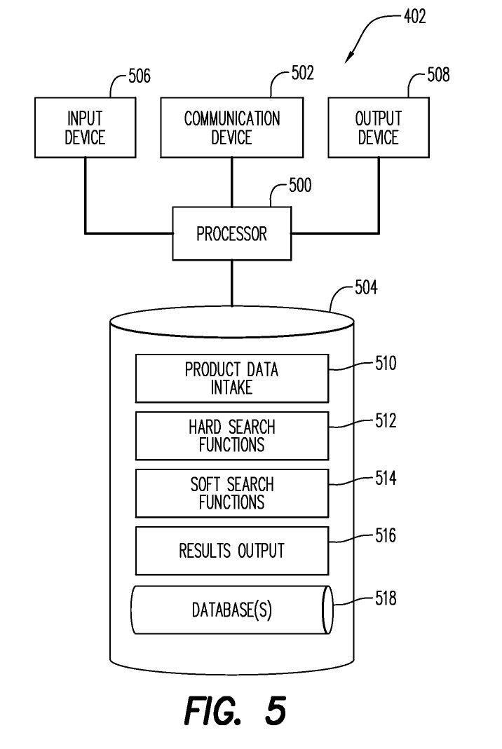

FIG. 5 is a block diagram that illustrates the subrogation screening server computer 402 shown in FIG. 4.

As depicted, the subrogation screening server computer 402 includes a computer processor 500 operatively coupled to a communication device 502, a storage device 504, one or more other input devices 506 and one or more output devices 508.

Communication device 502 may be used to facilitate communication with, for example, other devices (such as personal computers 410 assigned to individual employees of the insurance company and shown in FIG. 4, web servers, the data storage device 406, etc.). The input device(s) 506 may comprise, for example, a keyboard, a keypad, a mouse or other pointing device, a microphone, knob or a switch, an infra-red (IR) port, a docking station, and/or a touch screen. The input device(s) 506 may be used, for example, to enter information. Output device(s) 508 may comprise, for example, a display (e.g., a display screen), a speaker, and/or a printer.

Storage device 504 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. At least some of these devices may be considered computer-readable storage media, or may include such media.

In some embodiments, the hardware aspects of the subrogation screening server computer 402 may be entirely conventional.

Storage device 504 stores one or more programs or portions of programs (at least some of which being indicated by blocks 510-516) for controlling processor 500. Processor 500 performs instructions of the programs, and thereby operates in accordance with the present invention. In some embodiments, the programs may include a program or program module 510 that programs the subrogation screening server computer 402 to receive the product related data from the estimating process, as described above.

Another program or program module stored on the storage device 504 is indicated at block 512 and is operative to allow the subrogation screening server computer 402 to perform searches of databases (e.g., in external data sources 414) using product make, model and/or unit identifying number as at least part of the search query. The purpose of the searches is to identify product recalls for the make and model in question, or to access specific product unit history, such as the vehicle history in the case where the product is a motor vehicle. Programs 510 and 512 are provided in accordance with aspects of the present invention.

Still another program or program module stored on the storage device 504 is indicated at block 514. Program/module 514 controls the subrogation screening server computer 402 to perform “soft” information seeking activities (also referred to as “‘soft’ searching”) such as data mining or detection of relevant patterns in external data sources 414 and/or in company claim or event files that are not explicitly devoted to storing reports of product recalls or unit histories. Program 514 is provided in accordance with aspects of the present invention.

Storage device 504 also stores a program/program module 516, which operates to control the subrogation screening server computer 402 to output results of its efforts to identify subrogation opportunities.

There may also be stored in the storage device 504 other software, such as one or more conventional operating systems, device drivers, communications software, etc.

Still further, the storage device 504 may store various databases that are employed in connection with subrogation opportunity identification activities. Such databases are illustrated in FIG. 5 as block 518.

FIG. 6 is a flow chart that illustrates a process that may be performed by the subrogation screening server computer 402 in accordance with aspects of the present invention.

At 602 in FIG. 6, the subrogation screening server computer 402 receives at least an extract from the information generated by the estimating process in a prescribed format and with respect to a claim or loss event. For purposes of FIG. 6, it will be assumed that the loss event is a motor vehicle accident and that the information received by the subrogation screening server computer 402 includes the make, model, model year (and possibly also body type) and vehicle identification number (VIN) for at least one motor vehicle involved in the accident. The information received at 602 may include at least a general categorization of the accident and each vehicle's role in the accident. The information received at 602 may also include a general description of the claim or claims presented to the insurance company with respect to the accident.

At 604, the subrogation screening server computer 402 uses the make and model of the vehicle(s) involved in the accident to access one or more databases that contain information about product recalls by vehicle manufacturers. The database(s) may, for example, be accessible to the public and/or by subscription. The subrogation screening server computer 402 may store for analysis any instances of product recalls found in the database access(es) for the vehicle make(s) and model(s) involved.

At 606, the subrogation screening server computer 402 uses the VIN (s) for the vehicle(s) involved to access one or more databases that contain vehicle history information. The vehicle history information may, for example, indicate whether the vehicle(s) involved were in prior accidents or otherwise previously suffered damage. The vehicle history information may also indicate what prior repairs were made to the vehicle(s) involved, and by what repair shop(s) the repairs were made. The vehicle history database(s) may be accessible to the public and/or by subscription or membership. In addition or alternatively, the insurance company may—alone or in cooperation with other insurance companies—have collated vehicle history and prior repair data to produce a proprietary vehicle history database. The subrogation screening server computer 402 may store for analysis any instances of prior damage and repair found in the vehicle history database access(es) for the VIN (s) in question.

In contrast to the “hard” database queries that may be performed at 604 and 606, the subrogation screening server computer 402 may also perform data mining and/or pattern-recognition searching or other open-ended scanning and analysis, as collectively indicated at 608 in FIG. 6. For example, the subrogation screening server computer 402 may be programmed to access consumer product review bulletin boards or similar websites related to motor vehicles and may search such data sources using the make and model of the vehicle(s) in question as key words. The subrogation screening server computer 402 may use machine intelligence to analyze the context of any “hits” in these data sources to determine whether the consumer comments and the like are indicative of a pattern of reported problems for the vehicle make and model in question. Any detected pattern of reported problems may be stored for further analysis in regard to the specifics of the vehicle accident in question.

In another type of “soft” searching that may be performed at 608, the subrogation screening server computer 402 may use the make/model combination(s) in question as key words in searching news/press release databases (e.g., LEXIS/NEXIS, databases of court decisions, a data clearinghouse for subrogation proceedings, and/or one or more news databases related to the motor vehicle industry). Again the subrogation screening server computer 402 may analyze the context of any “hits” to detect a pattern of reported problems for the vehicle make and model, and may store the results for further analysis.

Further in regard to step 608, the subrogation screening server computer 402 may perform similar pattern recognition, data mining or other types of data analysis with respect to an accumulated historical claims database maintained by the insurance company itself and/or by a consortium of insurance companies. Such a database may, for example, store information concerning previous unrelated accident events, including the nature of the accident and the makes and models of the vehicles involved in the previous accidents. The “soft” searching with respect to insurance claim files may be designed to detect patterns that may evidence possible causation of accidents by vehicle defects.

It will be appreciated that the “soft” searching may be directed entirely to websites that do not include a vehicle recall database.

At 610 in FIG. 6, the subrogation screening server computer 402 may apply further analysis to the results of searching at 608. For example, the analysis at 610 may be designed to determine whether the nature of the accident and the nature of any acknowledged or suspected defect would support an inference that the accident or loss resulting therefrom may have been caused by a defect or defects in the vehicle(s). In addition to or instead of other types of analysis that may be performed at 610, the subrogation screening server computer 402 may follow up any finding of a prior accident involving one of the vehicles by determining whether the repair shop that repaired such a vehicle had the necessary capabilities to perform the type of repairs required in view of the damage suffered by the vehicle in the prior accident. For this purpose, the subrogation screening server computer 402 may access a historical database of repair shops and their capabilities. The capabilities of the repair shops may include the types of equipment installed in the repair shops and the types of training and certification of the individual employees of the repair shops. In a case where the repair shop for the prior repair did not have proper capabilities considering the type of damage incurred, the subrogation screening server computer 402 may further analyze the details of the current accident to determine whether there is support for an inference that an earlier faulty repair of the vehicle may have been a cause of the current accident. If so, the subrogation screening server computer 402 may identify an opportunity for a subrogation demand against the prior repair shop or against an insurer that recommended the prior repair shop.

At decision block 612, the subrogation screening server computer 402 determines whether it has identified an opportunity for a subrogation claim against a vehicle manufacturer or another party in connection with the accident. Such an opportunity may have been identified by the subrogation screening server computer 402 from any one or more of the recall database access at 604, the vehicle history database(s) access(es) at 606 or the “soft” searching and subsequent pattern recognition, data mining or other analysis at 608 and 610. The identification of a subrogation opportunity may also take into consideration whether an apparent vehicle defect was likely to be a cause of the accident given the vehicle's role in the accident.

If a positive determination is made by the subrogation screening server computer 402 at 612 (i.e., if it has identified a subrogation opportunity), then step 614 follows decision block 612. At decision block 612, the subrogation screening server computer 402 may forward the claim file in question (or at least the portion of the claim file accessible to the subrogation screening server computer 402) to a subrogation unit of the insurance company. This may be done, for example, by the subrogation screening server computer 402 automatically sending an electronic mail message to the subrogation unit or a member thereof. In some embodiments, the referral of the claim file or portions thereof from the subrogation screening server computer 402 to the subrogation unit may occur before the estimating process (FIG. 2, block 104a) has been completed. From previous discussion, it will be appreciated that the subrogation unit may further investigate the subrogation opportunity, may interact with the estimator to obtain further information about the accident, and may prepare, submit and prosecute a subrogation demand against the vehicle manufacturer or its insurer, if investigation indicates such a course of action to be warranted.

Following step 614, the subrogation screening server computer 402 may temporarily or permanently store (as indicated at 616) the results of its “hard” and “soft” searching and of subsequent analysis.

Considering again decision block 612, if the subrogation screening server computer 402 determines that it has not identified a subrogation opportunity with respect to the accident, the process may advance from decision block 612 directly to step 616 (i.e., without referring the claim file to the subrogation unit).

Up to this point in the example process of FIG. 6, it has been assumed that the subrogation opportunities to be identified have been related to possible manufacturing defects in vehicles or possible prior faulty repairs to vehicles. However, in other embodiments, the subrogation screening server computer 402 may also operate to identify possible subrogation opportunities involving defects in components of one or more of the vehicles involved in the accident. For example, the information available to the subrogation screening server computer 402 may include the make and model of the tires on the vehicles at the time of the accident. Using this information, the subrogation screening server computer 402 may access one or more product recall databases relating to vehicle tires. In addition or alternatively, the subrogation screening server computer 402 may engage in “soft” searching and analysis (as in steps 608 and 610) to detect possible patterns of reported problems with the make(s) and model(s) of the tires involved. Moreover, the subrogation screening server computer 402 may undertake similar processes with respect to after-market components known to have been installed in the vehicles in question. These processes may lead to identification of subrogation opportunities with respect to tire or after market component manufacturers.

According to other embodiments, the subrogation screening server computer 402 may additionally or alternatively operate to identify subrogation opportunities with respect to loss events other than vehicle accidents. For example, the subrogation screening server computer 402 may operate to identify subrogation opportunities with respect to building fires or explosions. In some embodiments, to identify such subrogation opportunities, the subrogation screening server computer 402 may engage in a process similar to that described above in connection with FIG. 6. For example, the information received by the subrogation screening server computer 402 from the estimating process (cf. 602 in FIG. 6) may include the make and model numbers for one or more appliances that were present in the building that suffered the fire or explosion. Using the appliance make and model information, along with the type of appliance in question, the subrogation screening server computer 402 may engage in “hard” searching of one or more product recall databases (cf. 604 in FIG. 6) and also may engage in “soft” searching/data analysis/pattern recognition in similar fashion to the activities described in connection with 608 and 610 in FIG. 6. The results of the “hard” and “soft” searching may be such as to support an inference that a defect in an appliance may have caused the fire or explosion, thus indicating an opportunity for subrogation against the manufacturer of the appliance. It should be noted that, as is also possible with respect to motor vehicles, the insurance company may maintain a database relating to past loss events from which patterns suggestive of product defects may be detected.

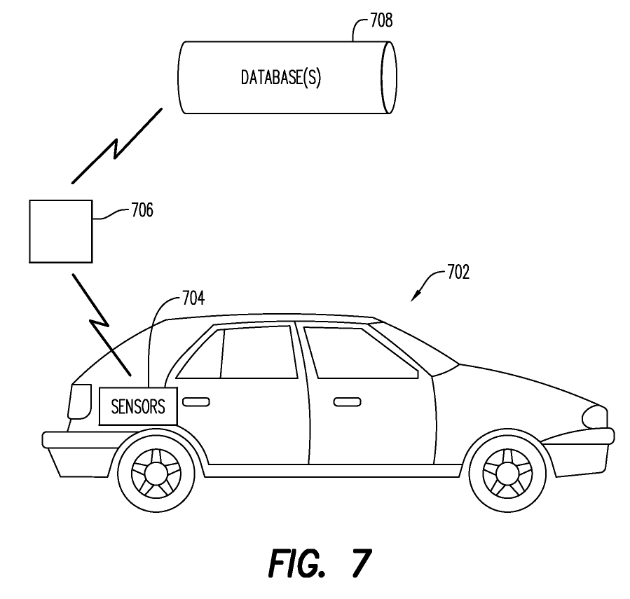

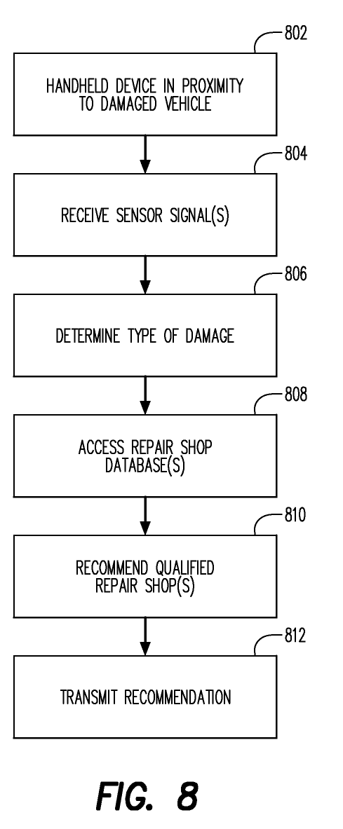

According to one aspect of the previous discussion, it may be advantageous to maintain a database of vehicle repair shops to compile a historical record of what capabilities the shops had at times in the past. Such a database could be derived from a repair shop database that indicates what capabilities the repair shops currently have, and the latter type of database may have value in connection with the insurance company's handling of current claims. FIGS. 7 and 8 are illustrative of a manner of using a current repair shop database.

In FIG. 7, reference numeral 702 indicates a motor vehicle. It is assumed for present purposes that the motor vehicle 702 has been in a collision and has suffered some damage, although no damage is expressly depicted in the drawing. It is also assumed that the motor vehicle 702 incorporates sensor technology of a type that has been previously proposed to aid a repair shop employee or other person in assessing the type and extent of damage suffered by the vehicle without requiring disassembly of the motor vehicle. For example, the sensors represented by block 704 may be installed at various strategic locations in the frame (not separately shown) and/or in other structural components (not separately indicated) of the motor vehicle 702. The function of the sensors is to provide signals indicative of damage suffered at the locus of the sensors 704. These signals may be compiled or translated by a suitable electronic device (not shown) that is also installed in the motor vehicle 702 and that is in communication with the sensors 704. These signals, with or without processing, translation or the like, may be communicated from the electronic device in the vehicle 702 to a handheld electronic device 706 held in proximity to the motor vehicle 702 by a claims handling employee or adjuster (not shown). The signals may be such as to allow the handheld electronic device 706 to determine what type of structural damage the motor vehicle may have sustained. Consequently, the sensors 704 may be considered to be “damage sensors”.

Typically the driver of the vehicle 702 is made aware that the sensors are present in the vehicle.

Block 708 in FIG. 7 represents one or more current repair shop databases that are accessible by the handheld electronic device 706. In preferred embodiments, the handheld electronic device 706 may be a personal digital assistant (PDA) or other small portable computing device with both short range and mobile communication capabilities. It is also assumed that the handheld electronic device can function as a mobile client with the capability of retrieving and downloading data from one or more remote server computers (not separately shown) which host the current repair shop database(s) 708.

FIG. 8 is a flow chart that illustrates a process that may be performed by/with the handheld electronic device 706.

At 802 in FIG. 8, the handheld device is held in proximity to the motor vehicle 702. (As used herein and in the appended claims, “in proximity to” should be understood to mean within 30 feet of the motor vehicle.) At 804, the handheld electronic device 706 receives a signal or signals originated from one or more of the sensors 704. A signal should be considered to have “originated” from one of the sensors if it is directly transmitted from the sensor, relayed from the sensor by another device or devices, or generated based on or in response to a signal generated by the sensor.

At 806, the handheld electronic device 706 determines the or a type of damage sustained by the motor vehicle 702. That is, the handheld electronic device 706 either infers or concludes that the motor vehicle 702 has sustained a certain type of damage based on the signal(s) received at 804, or the handheld electronic device 706 interprets or recognizes that the signal(s) received at 804 expressly or implicitly indicate a certain type or types of damage sustained by the motor vehicle 702.

At 808, and based on the type of damage determined at 806, the handheld electronic device 706 accesses the database(s) 708 to download data that identifies one or more repair shops that have the capabilities needed to repair the damage and are located near or relatively near the vehicle's (and the handheld electronic device's) current location. At 810, the handheld electronic device 706 may provide output that recommends the repair shop or repair shops identified by the data downloaded at 808. For example, the handheld electronic device 706 may display the contact information for the recommended repair shops on the display component (not separately shown) of the handheld electronic device 706. In addition or alternatively, the handheld electronic device 706 may transmit (step 812) the contact information for the recommended repair shops to another computing device, such as a server computer or a personal computer operated by an adjuster or claim handler or by the individual who owns the motor vehicle 702.

The process depicted in FIGS. 7 and 8 may aid the insurance company in providing recommendations as to repair shops that are fully qualified to provide proper repairs for vehicles that are subject to property damage claims.

The database(s) 708 shown in FIG. 7 may in some embodiments indicate that there are few repair shops that are qualified to repair certain makes or models of vehicles. This information may be taken into account in making underwriting decisions regarding those make or models of vehicles.

Referring again to the process of FIG. 6, it is indicated in FIG. 6 that only one vehicle recall database is accessed at 604, but alternatively two or more vehicle recall databases may be accessed. By the same token, the number of vehicle history databases accessed at 606 may be one, two or any other number.

The subrogation opportunities referred to herein may relate to payments made for either or both of property damage or bodily injury claims.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system comprising:
a data capture module for capturing at least one of a make, a model and a unit identification number for a vehicle involved in a loss event;
a data storage module in communication with the data capture module, said data storage module for storing the at least one of a make, a model and a unit identification number for the vehicle involved in the loss event;
a computer processor in communication with the data storage module for analyzing information related to the vehicle to detect a pattern of reported problems involving said vehicle; and
an output device, coupled to the computer processor, for outputting an identification of a subrogation opportunity based on the detected pattern.

2. The computer system of claim 1, wherein the computer processor searches a database using the at least one of the make, model and a unit identification number for the vehicle involved in the loss event.

3. The computer system of claim 2, wherein the computer processor retrieves said information from said database.

4. The computer system of claim 1, wherein:
the data capture module captures event information indicative of at least one attribute of the loss event other than said make, model and unit identification of the vehicle; and
the data storage module stores the event information.

5. A computerized method comprising:
receiving, in a computer, first data that represents at least one of a make, a model and a unit identification number for a physical object involved in a loss event;
receiving, in the computer, second data that represents at least one attribute of the loss event not indicated by the first data;
the computer accessing at least one database using at least said first date to receive or gather third data from said at least one database;
the computer using at least said second and third data to identify a subrogation opportunity with respect to the loss event; and
the computer outputting the identified subrogation opportunity to a workflow device.

6. The method of claim 5, wherein:
the loss event involves a motor vehicle; and
the unit identification number is a vehicle identification number of the motor vehicle.

7. The method of claim 6, wherein the loss event is a motor vehicle accident, and the second data includes a description of the motor vehicle accident.

8. The method of claim 6, wherein the at least one database includes a vehicle history database.

9. The method of claim 5, wherein the physical object is a component of a motor vehicle.

10. The method of claim 5, wherein the loss event involves a building and the physical object is an appliance installed in the building.

11. The method of claim 5, wherein the at least one database includes a product recall database.

12. A computerized method comprising:
receiving, in a computer from an input device, first information that represents a make and model for a physical object involved in a loss event;
the computer automatically analyzing second information to detect a pattern of reported problems involving said make and model;
the computer automatically identifying a subrogation opportunity based on the detected pattern; and
the computer outputting, to an output device, third information indicative of the identified subrogation opportunity.

13. The method of claim 12, wherein said analyzing includes an internet search using said make and model as search terms, and data mining results of said internet search.

14. The method of claim 12, wherein said second information includes consumer comments on a website.

15. The method of claim 12, wherein said second information includes claim data of at least one insurance company.

16. The method of claim 12, wherein:
the loss event involves a motor vehicle accident; and
the physical object is the motor vehicle.

17. The method of claim 12, wherein:
the loss event involves a motor vehicle accident; and
the physical object is a component of the motor vehicle.

18. The method of claim 12, wherein the loss event involves a building and the physical object is an appliance installed in the building.

19. The method of claim 12, further comprising:
basing an underwriting decision on the identified subrogation opportunity.

20. The method of claim 12, further comprising:
providing an indication that the loss event involves a bodily injury or involves a possibility of a bodily injury.

21. A computer system comprising:
a data capture module for capturing at least one of a make, a model and a unit identification number for a vehicle involved in a loss event;
a data storage module in communication with the data capture module, said data storage module for storing the at least one of a make, a model and a unit identification number for the vehicle involved in the loss event;
a computer processor in communication with the data storage module for (a) analyzing information related to the vehicle to detect a pattern of reported problems involving said vehicle, (b) accessing at least one vehicle history database to determine a prior repair history for said vehicle, and (c) accessing a vehicle recall database to determine whether said vehicle has been subject to a manufacturer's recall; and
an output device, coupled to the computer processor, for outputting an identification of a subrogation opportunity based on at least one of (a) the detected pattern, (b) said prior repair history for said vehicle, and (c) said manufacturer's recall.

22. A method comprising:
determining a make, a model and a vehicle identification number for a motor vehicle that has been involved in an accident;
using said make and model to access a vehicle recall database to determine whether said motor vehicle has been subject to a manufacturer's recall;
using said vehicle identification number to access at least one vehicle history database to determine a prior repair history for the motor vehicle;
using said make and model to search the internet and/or at least one website to detect a pattern in reported problems involving said make and model;
identifying a subrogation opportunity based on at least one of (a) said access to said vehicle recall database; (b) said access to said at least one vehicle history database; and (c) said detected pattern of reported problems; and
outputting the subrogation opportunity to a workflow device.

23. The method of claim 22, wherein:
said subrogation opportunity is identified during a period of time prior to completion of a loss estimation process with respect to the accident.

24. The method of claim 22, further comprising:
determining capabilities of a vehicle repair shop that repaired the motor vehicle prior to the accident.

25. The method of claim 24, further comprising:
detecting a mismatch between the capabilities of the vehicle repair shop and damage suffered by the motor vehicle prior to the accident.

26. A method comprising:
receiving a signal originated by a damage sensor installed in a motor vehicle;
determining, based on the received signal, a type of damage sustained by the motor vehicle;
using the determined type of damage to access a database of vehicle repair shops; and
based on the database access, identifying vehicle repair shops that have a capability for repairing the determined type of damage.

27. The method of claim 26, wherein:
the signal is received by a handheld electronic device;
the handheld electronic device is used to access the database of vehicle repair shops; and
information that identifies recommended vehicle repair shops is displayed to a user by the handheld electronic device.

28. The method of claim 27, further comprising:
transmitting the information from the handheld electronic device.

29. The method of claim 27, wherein the signal is received by the handheld electronic device while the handheld electronic device is in proximity to the motor vehicle.

30. The method of claim 26, further comprising:
basing an underwriting decision of on information contained in the database of vehicle repair shops.
